(19) United States
(12) Patent Application Publication
(10) Pub. No.: US 2020/0323248 A1
(43) Pub. Date: Oct. 15, 2020

(54) MACHINE FOR PUFFING POPCORN AND OTHER GRAINS AND SEEDS

(71) Applicant: Enrique Antonio ÁLVAREZ DÍAZ, México (MX)

(72) Inventor: Enrique Antonio ÁLVAREZ DÍAZ, México (MX)

(21) Appl. No.: 16/766,740

(22) PCT Filed: May 22, 2018
(86) PCT No.: PCT/MX2018/000047

§ 371 Date: May 25, 2020

(30) Foreign Application Priority Data
Jan. 25, 2018 (MX) MX/A/2018/001124

(51) Int. Cl. A23L 7/187; A23L 7/191

(52) U.S. Cl. CPC A23L 7/187; A23V 2002/00; A23L 7/191

(57) ABSTRACT

The present invention refers to the manufacturing of devices for the production of snacks. Specifically, to the manufacture of devices which allow grains and seeds to increase its size by incorporating air and making them crunchier but less harsh at the same time and more particularly to achieve a grain and seed bursting equipment, which overcomes the resistance that a high viscosity fluid such as sucrose caramel opposes. Structurally, the popping machine for corn and other grains and seeds is characterized by comprising a base structure, on which there is a discharge hopper for collecting the popped product in its lower part, and in the upper part there is a concentric hexagonal burner, a base, which in its central part presents the union of two bolts, attached to a third bolt with draggers which is placed inside the main container with a lid.

### FIELD OF INVENTION

The present invention refers to the manufacturing of devices for the production of snacks. Specifically, to the manufacture of devices which allow grains and seeds to increase its size by incorporating air and making them crunchier but less harsh at the same time.

### BACKGROUND OF THE INVENTION

Popcorn machines for a concession stand, a restaurant or domestic use are well known. In general, such popping machines incorporates a cabinet or case in which the popcorn is cooked and stored. The non-popped corn (grains) is typically placed in a container which is suspended from the upper section of the popcorn box, mixed with cooking oil and the mix is heated. The bowl is a metallic container with an open lid which allows a heat distribution to the grains and oil. This container has electric or gas heating elements which elevates the temperature of the corn grains and the oil, and therefore it provokes the popping of the grains.

The container has a lid to cover it during the grain popping process. The container is heated by the heating elements to burst the popcorn within the chamber. The lid prevents the release of the popcorn and oil until the sweeping process is almost complete. The lid may include a hinged portion that opens as the volume of the popcorn increases inside the chamber. When the popping operation is complete, the chamber assembly is usually tilted, opening the lid, to release the remaining popped popcorn for service.

The use of cooking oil functions to coat the corn grains to ensure a uniform heat distribution throughout the grain. Furthermore, it is necessary to displace or give movement to the grains preventing them from burning at the bottom of the container where more heat is applied. In order to mix the corn grains with the cooking oil, and to ensure an even popping of all the corn, a dragging mechanism is usually provided inside the container. The dragging mechanism is typically a rotating drag blade, which is turned by a rotor shaft of the dragging assembly that is driven by a conventional electric motor. In a bottom-mounted popcorn bursting container, the agitator's rotor shaft enters the popping container through a centrally located opening in the bottom of the popping container.

In other configurations, the agitator rotor shaft will enter the water heater through an opening in the lid. Unfortunately, in any of these configurations, the lid of the water heater, and the heater itself must be tilted, which interferes with the rotor shaft that must be inserted into the water heater during the cooking process. Therefore, the rotor shaft must be disconnected when the container is tilted and reconnected for the grain cooking process. This connection and reconnection processes require a greater mechanical complexity in the container assembly and popcorn designs. Furthermore, the use of this mechanism is inherently unreliable. Therefore, there is a need for a popcorn burst container integrated with a self-contained stirring mechanism. There is an additional need for a popcorn bursting container that does not require excessive mechanical parts to remove a dragging element when the container is tilted after the popping process.

There is also a need for a container to heat the popcorn grains with integrated components that does not require additional elements mounted outside the container.

And this which is true for popcorn grains, is also true for popping amaranth, sesame and pumpkin seeds, among others.

In the devices for the bursting of grains and seeds of the state of the art, there is the inconvenience of not providing enough force as necessary to allow the dragging of the grains to burst, when for example the production of caramelized popcorn is required and it is necessary to add sugar to the grains before popping them.

The state-of-the-art devices have solved this situation by making special syrups whose rheological characteristics are such that they do not overload the dragging elements. Or they carry out the caramel coating of the popcorn, separately and out of the popping container

In addition, for some non-obvious unknown reason, the grain's dragging element is driven by a motor placed in the upper part of the container where the bursting of the grains or seeds take place.

Cretor's U.S. Pat. No. 6,374,727 describes an integrated popcorn heater used in conjunction with a popcorn machine. The popcorn heater has a cooking chamber with a hinged lid. An engine chamber is located under the cooking chamber. An electric motor is located in the motor chamber and turns a stirrer in the cooking chamber. The bottom of the cooking chamber has a heating element that is used to cook the popcorn. The motor is activated to turn the agitator to ensure the heat distribution for the popcorn. The entire popcorn heater, including the engine chamber and the cooking chamber, may pivot as one unit to remove the finished popcorn. In this configuration, no additional mechanical parts are required to suspend the stirrer in the heater.

In Wood et al's U.S. Pat. No. 5,711,208, a device for bursting and storing with heat the popped corn includes a cabinet with stoves and service chambers side by side preferable, but not necessarily, which are separated by a partition. A rear side of the cabinet provides access to both chambers through one or two common rear doors or openings, while a front side of the cabinet provides access only to the storage chamber through a front door or opening. Preferably, any front door should be closed automatically.

Kiczek's U.S. Pat. No. 4,763,568 describes a popcorn popping device that uses an oil heating mechanism with a pair of heating elements to elevate the temperature of the uncrushed grains to form popcorn. The popcorn bursting device includes a base element and a heating mechanism to raise the temperature of the oil and the uncrushed grains to form popcorn. Alternatively, the heating mechanism includes an air heating mechanism.

There are several known popcorn bursting devices that use oil to heat the corn grains. For example, Hobbs, U.S. Pat. No. 2,570,126, Hughes, U.S. Pat. No. 3,611,910 and Kiczek U.S. Pat. No. 4,445,427.

Several types of popcorn bursting devices using hot air have been proposed, and the following are some examples. Wolens, U.S. Pat. No. 3,756,139, Crabtree et. Al. U.S. Pat. No. 4,178,843, Richardson, U.S. Pat. No. 4,072,091, Lidenman U.S. Pat. No. 3,059,567; Grant and the U.S. Pat. No. 3,323,440. In these types of poppers, no oil is applied to burst the corn grains, but rather dry corn grains are used as raw material. The grains are suspended in a stream of hot air or other inert gas until the heat causes the grains to expand and form popcorn. Then, the same stream of hot air carries the popcorn to a separate location.

The oil method has advantages and disadvantages over the air extraction method. Neither method has been superior in the eyes of the consumer. It is for this reason that the best-known popcorn bursting devices use the oil method or use the air heating method.

### OBJECTIVES OF THE INVENTION

One of the objectives of the present invention is to make possible the creation of a grain and seed bursting equipment which allows the conditioning of an important horsepower engine.

Another goal is to achieve a robust, heavy duty grain and seed bursting device.

Yet another goal is to achieve a grain and seed bursting equipment, which overcomes the resistance that a high viscosity fluid such as sucrose caramel opposes.

Yet another goal is to achieve a grain and seed bursting equipment that is so versatile as to allow the preparation of such grains or seeds with a caramel coating, for example,

And all those objectives and advantages will become evident from the reading of the present description accompanied by the figures which are an integral part of it and are added for illustrative but not restrictive purposes.

### BRIEF DESCRIPTION OF THE INVENTION

The present equipment for the busting of grains and seeds is made up of several important elements. On the one hand, we have the container, placed vertically, in the bottom of which the seeds or grains to be burst or covered will be placed on the upper face. On this upper face of the container's bottom wall, some combs are moved which will allow the grains and seeds to detach from the upper face of the container's bottom wall, for some time, in order to avoid them to be burned before bursting. Since the outside temperature is higher than the inner temperature due to the speed of heat transfer from the outer layers of the grains or seeds to its inner layers, it is necessary to give the temperature the opportunity to homogenize in every layer, so that the burst is uniform and the cooking process is not taken away by charring the outer layers while the inner ones do not reach the bursting temperature.

Another important element is the engine's movement transmission system, which is located in the lower section. Due to its weight, which becomes important because of the power required to give movement to the rod that rotates in a parallel way and very close to the upper face of the bottom wall of the container especially when the rheology of the product to be moved requires it.

The engine is equipped with a motor reducer, since the speed required in the combs or rods to drag the product in the container, is low, say 20 turns per minute or less than (20 RPM). On the other hand, this speed reduction results in a gain in torque.

The device has a support structure where the lower part will have a plate that will rest on the structure and the upper part of this plate will support the so-called burner base, which in addition to supporting the burner will keep the combustion gases contained. It consists of a cylinder made up of a laminated sheet with nails welded to the lower part of the burner base. It is in these nails that the burner is held. It also has welded nails near the top and one or more hinges that will hold the container. In addition to the nails the container is held by hinges fixed to the base of the burner. These hinges will allow the container to be tilted in order to empty the burst contents.

The plate has two holes of appropriate dimensions for the passage, in one case, of the tube that conducts the gas that will feed the burner and in the other the bolt that at its upper section comprises a disc with two other bolts in a diametrical opposite position on the edge of its perimeter. These bolts, when projected upwards, will turn a horizontal bolt welded to a vertical bolt which is firmly attached to the shaft which includes the combs or rods for dragging the contents of the container, in order to give a movement which will allow the heating of these contents by radiation rather than by contact. The horizontal bolt, not being attached to the vertical bolts, allows the container to be tilted forward to collect the burst seeds or grains.

### BRIEF DESCRIPTION OF THE FIGURES

FIG. 1 is an exploded view or drawing of the entire popcorn device.

FIG. 2 illustrates the burner in detail.

FIG. 3 illustrates on its lower side the hole in the container through which the bolt passes. This bolt includes the draggers at its upper end.

FIG. 4 illustrates the detail of the disc with the peripheral bolts projected upwards and at the opposite end its attachment to the geared motor shaft.

FIG. 5 illustrates the inverted T-bolt to which a central bolt with the draggers is attached.

FIG. 6 illustrates the upper bolt to which the draggers are solidly fixed.

FIG. 7 illustrates the detail of the container lid with the rod that allows the lid to be rotated upwards and the product to be removed after it was burst.

FIG. 8 illustrates the bass on which the burner and container are supported

### DETAILED DESCRIPTION OF THE INVENTION

For the detailed description of the invention, which is the one that gives the enabling character to this patent, we will rely on the figures provided with illustrative, but not restrictive purposes, which are an integral part of the present description.

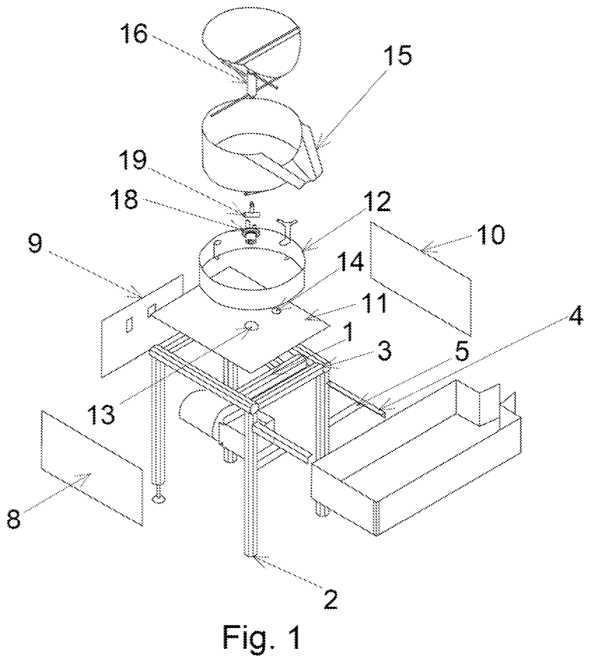

FIG. 1 is an exploded view or drawing of the entire popcorn device. Element 1 is the support structure or skeleton of the device. It is formed by vertical profiles 2, horizontal profiles 3 forming the main structure. Immediately, it has profiles 4 attached to the main structure, which because it is in cantilever requires additional supports 5, where the discharge hopper will be supported in which the contents of the container will be emptied for subsequent packaging or bagging

In one of the modalities, the bursting device has a support (not illustrated) at the bottom of the support structure where the geared motor will be supported to cover the inside of the main structure 1, this support has two side covers (8 and 10), and a rear cover 9. At its top end, the main structure 1 has what could be called a top cover 11, where the base of the burner will be supported 12

The top cover 1 comprises two holes, a central one 13 and another one loaded towards an edge 14. The first one has the function of allowing the passage of a bolt 18 which at one of its ends, the lower one, will be mechanically connected to the upper end of the geared motor shaft. At the upper end, this bolt ends in a disk with two diametrically opposed vertical bolts near the periphery of the disk. Between these vertical bolts there shall be a separate horizontal bolt, in the middle of which a vertical pin 19 shall be fixed solidly to the upper bolt 16 comprising the lower and upper draggers.

In the hole 14 loaded towards one of the side edges, it will pass from the bottom to the top of the lid, the tube that conducts the gas that will feed the burner, this is not illustrated in this figure.

On the upper cover 11, the burner base formed by a laminated sheet is placed. This base is also the support for the container 15. For the burner support, the base has a series of nails projected towards the center at the lower end. To support the container, near its upper end, the burner also has a series of nails and hinges, so that in addition to supporting the container, it has the capacity to pivot, to deposit the product in the discharge hopper and be able to pack or bag it. For this purpose, the container includes a front window with a spillway.

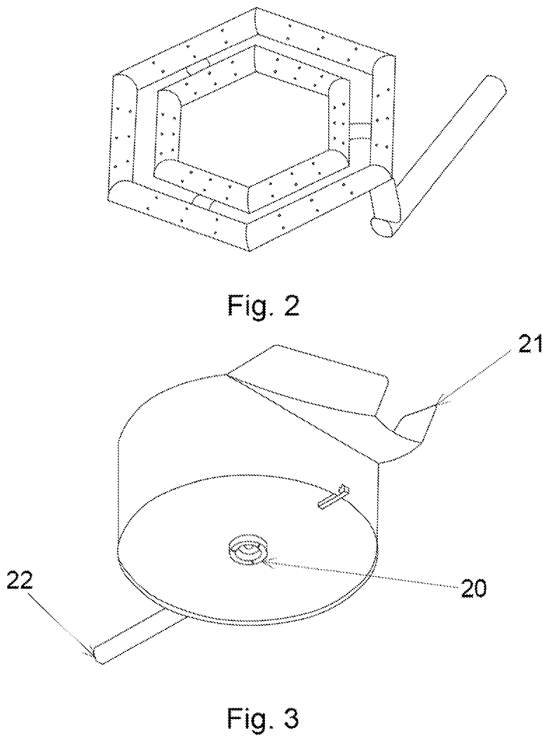

FIG. 2 illustrates the burner in detail. In order for this burner, to provide the necessary amount of calories from the combustion gases, besides having a dimension very close to the diameter of the container, has two concentric hexagonal rings, thus achieving a more homogeneous heat transfer in the main container 15, having the option of regulating the intensity of the flame by means of a key that regulates the flow of gas to the burners. The aforementioned is possible thanks to the fact that these rings have holes around its periphery where the combustion of the gas will come out in the form of a flame, thus avoiding the carbonization of the product that is contained inside.

FIG. 3 illustrates on its lower side the hole 20 of the container through which the pin passes at its upper end, comprising the draggers. The container has a flange at the top which is made up of 3 sheets joined in such a way that they have the shape of a funnel, in which it has a decrease in length of its ends, one of them is wider and joined to the container, and another at the opposite end, less wide, as an exit for when the product is finished.

Likewise, on the opposite side of the product's outlet flange there is a protrusion 22 which consists of a tube which serves as a support and has the capacity to pivot, to deposit the product in the discharge hopper and be able to pack or bag it.

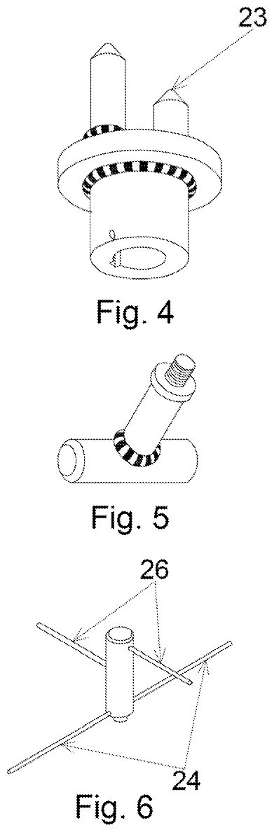

FIG. 4 illustrates the detail of the disc with the peripheral bolts projected upwards and at the opposite end its connection to the geared motor shaft. Both pins 23 are similar in size and whose end is given in a conical shape and are arranged in such a way that an inverted T-shaped bolt can be incorporated between them, and when the geared motor is activated the mechanism that will allow the correct transfer of heat of the product on the oil in a homogeneous way begins to rotate. The method of assembly with the main container is by means of an independent assembly of the geared motor, since at the end of the popcorn burst process, the inverted bolt may be removed but not the lower pin.

FIG. 5 illustrates the inverted T-shaped bolt on which a central shaft with the draggers is fixed. This T-shaped bolt performs the function of a device bearing with the draggers, this bolt in its lower part, thanks to its characteristic, fits on the disc with peripheral bolts, and it also has the functionality of, once the bursting of the grains placed in the main container is finished, it allows the emptying of the product, tilting the container, and when it is placed in its natural position it sets again between the lower bolts and consequently, the machine is activated again.

FIG. 6 illustrates the upper bolt to which the draggers are solidly fixed, at the bottom it is attached to the inverted bolt FIG. 5, in the lower section there is a pair of draggers 24 placed opposite to each other, which will have the function of homogenizing the product that has not yet burst, so that subsequently the bolts 25 placed in the upper part of the pin, which are placed opposite but unevenly, perform their function, homogenizing the product already popped, which will be taking a greater height in the container, these draggers as a whole are going to present the functionality of allowing the incorporation of caramels, which by their rheology, will not present any difficulty when distributing and finishing the bursting of the main product.

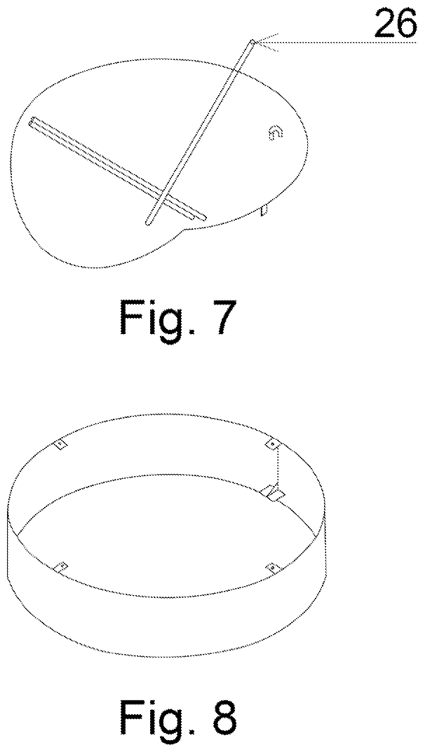

FIG. 7 illustrates the detail of the lid of the container with the rod 26 that allows to turn the lid upwards in order to extract the product after bursting. This lid is circular, but in its secant, it presents a movable tab directed towards the lower part, which when bursting the popcorn, due to the inertia of the popping process of the product, will allow its exit gradually.

FIG. 8 illustrates the base on which the burner and the container are supported. This base has nails 27 and hinges, projected towards the center, these tabs will allow the correct fastening of the main container, and at the same time have the capacity to pivot, to deposit the product in the discharge hopper and be able to pack or bag it.

On the other hand, the container has some joint elements, which correspond to other hinge elements which as a whole make possible for the container to be tilted in order to remove the burst grains and seeds.

The invention has been sufficiently described so that a person with average knowledge in the matter can reproduce and obtain the results mentioned in the present invention. However, any skilled person in the field of technology covered by the present invention may be capable of making modifications not described in this present application; nevertheless, if for the application of these modifications in a given product or in the manufacturing process thereof, the matter requested in the following claims is required, such structures shall be included within the scope of the invention.

Having described the invention, it is considered a as novelty and is therefore claimed as property, what is contained in the following claims:

1. Popping machine for corn and other grains and seeds characterized by comprising a base structure, on which a discharge hopper for harvesting the burst product is arranged in its lower part, and in its upper part includes a concentric hexagonal burner, a base, which in its central part presents the union of two bolts, where a third bolt with draggers is attached, which is placed inside the main container with a lid.

2. Popping machine for corn and other grains and seeds, as described in the previous claim, characterized by having a disk with the bolts projected upwards, which is fixed to a geared motor activated thereof, causing the bearing of the draggers in the main container to homogenize the product contained.

3. Popping machine for corn and other grains and seeds, as described in the previous claim, characterized by a base with nails and hinges bent towards the center which have the capability of rotating in a pivoting way, to deposit the product in the discharge hopper to pack or bag it.

4. Popping machine for corn and other grains and seeds, as described in claim 2, characterized by the operation of the bolt with draggers which is by means of the use of an inverted T-shaped bolt, which fits the bolt with the upper projections and when the geared engine is activated, it starts the operation of the draggers, and when the container is tilted, it stays in the main container allowing to stop the equipment's bearing. Once it returns to its original position, it restarts the process.

5. Popping machine for corn and other grains and seeds, as described in the previous claim, characterized by the fact that the draggers are arranged on a central bolt, with 2 at the proximal end meeting each other and 2 other upper bolts placed on a slope.
